(19) United States
(12) Patent Application Publication
(10) Pub. No.: US 2019/0109954 A1
(43) Pub. Date: Apr. 11, 2019

(54) IMAGE INSPECTION APPARATUS AND COMPUTER-READABLE RECORDING MEDIUM STORING A PROGRAM

(71) Applicant: KONICA MINOLTA, INC., Tokyo (JP)

(72) Inventor: Yasushi Tsue, Tokyo (JP)

(73) Assignee: KONICA MINOLTA, INC., Tokyo (JP)

(21) Appl. No.: 16/130,250

(22) Filed: Sep. 13, 2018

(30) Foreign Application Priority Data
Oct. 6, 2017 (JP) 2017-196283

(51) Int. Cl. H04N 1/00; B41F 33/00; G06T 7/00

(52) U.S. Cl. CPC H04N 1/00328; H04N 1/00005; G01N 21/892; G06T 7/0004; B41F 33/0036

(57) ABSTRACT

An image inspection apparatus includes: an acquirer that acquires a targeted image to form an image; an alignment calculator that calculates a correction parameter in order to align a targeted image with a read image; an alignment corrector that corrects at least one of a targeted image and a read image by using the correction parameter; and an image inspector that determines a flaw in a read image based on a difference between the targeted image and the read image corrected by the alignment corrector. The alignment corrector saves the correction parameter on a page basis and uses the correction parameter corresponding to a page including an image when aligned.

### CROSS-REFERENCE TO RELATED APPLICATIONS

The entire disclosure of Japanese Patent Application No. 2017-196283, filed on Oct. 6, 2017, is incorporated herein by reference in its entirety.

### BACKGROUND

### Technological Field

The present invention relates to an image inspection apparatus to check an image formed on paper by an image forming apparatus and a computer-readable recording medium storing a program to perform image inspection.

### Description of the Related Art

As a related art, there is practically available an image inspection apparatus that optically reads an image formed on paper by an image forming apparatus and inspects whether the image is formed correctly. By checking an image, the image inspection apparatus can detect partial stain in the image, for example.

The inspection by the image inspection apparatus needs to correct positional misalignment between an original image and an image as a test object formed on paper, for example, and accurately align the two images.

The positional misalignment between two images occurs when an image is printed on paper and when the image printed on the paper is scanned.

During printing, the positional misalignment occurs due to shift, rotation, or magnification of an image caused by the position to start writing the image, a paper skew, and shrinkage of the paper when fused. During scanning, the positional misalignment occurs due to shift, rotation, or magnification of an image caused by the position to start reading the image, a paper skew, and a variation in the scan speed.

Of these factors, the shrinkage of paper when fused or the scan speed varies significantly with apparatus models or paper types. There is therefore hardly any issue in comparing two sheets of image data scanned on the same apparatus. However, relatively significant positional misalignment may occur when original image data before printing is compared with image data resulting from scanning the image printed on paper.

Many positional misalignment factors (such as shift, rotation, and magnification) to be corrected, if any, require a large amount of arithmetic processing for alignment processes on the image inspection apparatus when comparing two pieces of image data. There has been an issue of increasing the time required for the inspection and hampering the real-time inspection with no wait time.

For example, Patent Literatures 1 and 2 describe known related arts to perform alignment on an image inspection apparatus in a short period of time. Patent Literature 1 describes the technology that uses the same alignment parameter for sheets of paper to be inspected successively and thereby reduces the amount of arithmetic processing for alignment.

Patent Literature 2 describes the technology that provides a table of magnifications dependent on printing rates or print types such as one-side printing and both side printing, finds a magnification without performing arithmetic processing, and performs alignment while the magnification belongs to three correction parameters (image shift, rotation, and magnification) needed for the alignment and requires the time and the amount of arithmetic processing for calculation.

### CITATION LIST

### Patent Literature

Patent Literature 1: JP 2013-57929 A

Patent Literature 2: JP 2014-153553 A

### SUMMARY

The technology described in Patent Literature 1 can be applied only to continuous printing on the same type of paper. Namely, the type of paper differs from page to page in a printed material (such as a school yearbook) that is a mixture of photo pages and text pages, for example. Considering that different types of paper are used from page to page, it is highly likely that a paper feed tray used for the image forming apparatus during printing differs from page to page and the paper position or skew varies with pages. The use of the same alignment parameter for successive pages may therefore disable the image inspection apparatus from correctly performing the alignment.

The technology described in Patent Literature 2 sets the magnification parameter to a value selected from the table based on the print type and cannot deal with magnification variations due to subtle feeding speed differences during actual scanning caused by variations in apparatus models or differences in the types of paper. The image inspection is therefore performed under conditions of inappropriate alignment and causes incorrect detection of a stain or distortion.

It is an object of the present invention to provide an image inspection apparatus and a computer-readable recording medium storing a program capable of performing an alignment process with a small amount of arithmetic processing in a short period of time and performing near real-time inspection.

To achieve at least one of the above-mentioned objects, an image inspection apparatus according to one aspect of the present invention is configured as follows.

The image inspection apparatus according to one aspect of the present invention reads an image formed on paper by an image forming apparatus, acquires a read image, and inspects the read image.

There are provided: an acquirer that acquires a targeted image from the image forming apparatus to form an image; an alignment calculator that calculates a correction parameter in order to align a targeted image with a read image; an alignment corrector that corrects at least one of a targeted image and a read image by using the correction parameter; and an image inspector that determines a flaw in a read image based on a difference between the targeted image and the read image corrected by the alignment corrector.

The alignment corrector saves the correction parameter on a page basis and uses the correction parameter corresponding to a page including an image when aligned.

To achieve at least one of the above-mentioned objects, a computer-readable recording medium storing a program according to one aspect of the present invention stores a program that performs processes shown below.

The computer-readable recording medium storing a program according to one aspect of the present invention is applied to a program that is installed on a computer to read an image formed on paper by an image forming apparatus, acquire a read image, and inspect the read image.

The program performs: an acquisition process that acquires targeted image to form an image; an alignment calculation process that calculates a correction parameter to align the targeted image with the read image; an alignment correction process that corrects at least one of the targeted image and the read image by using the correction parameter; and an image inspection process that determines a flaw in the read image based on a difference between the targeted image and the read image corrected by the alignment correction process.

The alignment correction process saves the correction parameter on a page basis and uses the correction parameter corresponding to a page including an image when aligned.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating a configuration example of the image inspection apparatus according to a first embodiment of the present invention;

FIG. 2 is a configuration diagram illustrating an example of an image forming apparatus containing the image inspection apparatus according to the first embodiment of the present invention;

FIG. 3 is a flowchart illustrating an example (proof printing) of an image inspection process according to the first embodiment of the present invention;

FIG. 4 is a flowchart illustrating an example (mass printing) of the image inspection process according to the first embodiment of the present invention;

FIG. 5 is an explanatory diagram illustrating an overall flow of the image inspection process according to the first embodiment of the present invention;

FIG. 6 is an explanatory diagram illustrating a variable region in a print image;

FIG. 7 is a flowchart illustrating an example (proof printing) of an image inspection process according to a second embodiment of the present invention;

FIG. 8 is a flowchart illustrating an example (mass printing) of the image inspection process according to the second embodiment of the present invention; and

FIG. 9 is an explanatory diagram illustrating an overall flow of the image inspection process according to the second embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

The first embodiment of the present invention will be described.

1-1. Configuration of the Image Inspection Apparatus

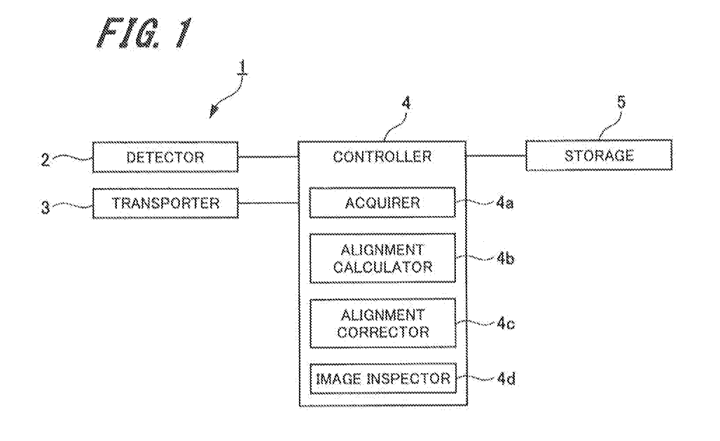

FIG. 1 is a function block diagram illustrating an image inspection apparatus 1.

The image inspection apparatus 1 includes a detector 2, a transporter 3, a controller 4, and a storage 5. The detector 2 includes a line image sensor that reads an image formed on paper. The transporter 3 transports paper in interlock with reading by the detector 2. The controller 4 controls the whole of the image inspection process. The storage 5 stores data (such as correction parameters) needed for control by the controller 4.

The controller 4 includes an acquirer 4a, an alignment calculator 4b, an alignment corrector 4c, and an image inspector 4d.

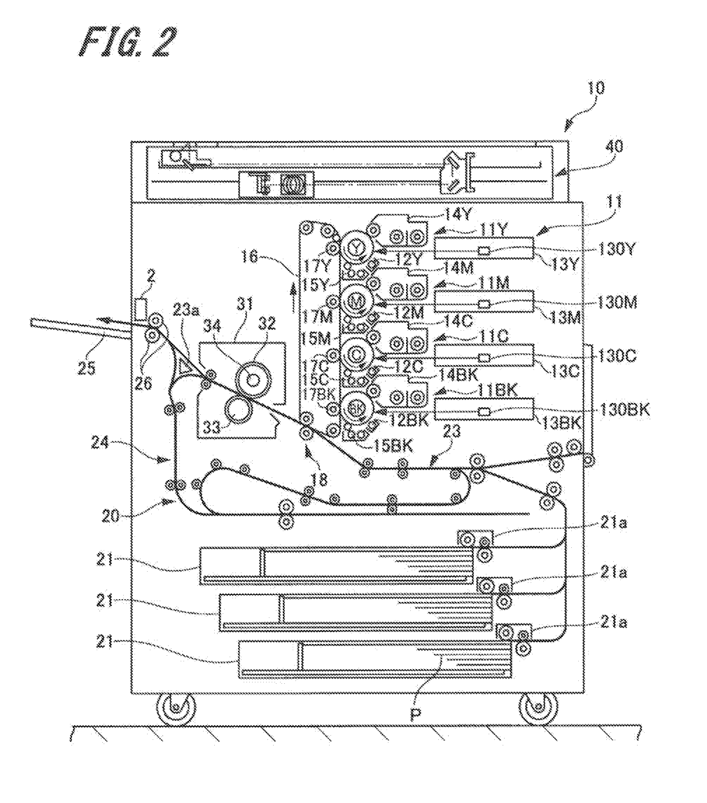

The acquirer 4a acquires data for an output-targeted image to be formed on paper by an image forming apparatus 10 (FIG. 2). In the description below, the output-targeted image is abbreviated as a targeted image. Data for the targeted image (output-targeted image) is also referred to as RIP (Raster Image Processor) data.

The alignment calculator 4b performs an alignment calculation process that calculates a correction parameter (alignment parameter) in order to align read image data acquired by the detector 2 with RIP data acquired by the acquirer 4a. However, two pieces of data compared by the alignment calculator 4b may not be limited to the RIP data and the read image data as will be described with reference to a flowchart.

The alignment corrector 4c performs an alignment correction process that corrects an image for either or both the RIP data and the read image data by using the correction parameter calculated by the alignment calculator 4b. The alignment corrector 4c performs a variable magnification process, a shift process, and a rotation process. The variable magnification process is performed to correct a size error between the RIP data and the read image data. The shift process is performed to correct an error in positions of images for the RIP data and the read image data. The rotation process is performed to correct an error in rotational states of images for the RIP data and the read image data.

The image inspector 4d determines a flaw in the read image by detecting a difference using the data corrected by the alignment corrector 4c. A determination result from the image inspector 4d is displayed on a display (not shown) connected to the image inspection apparatus 1. Paper transportation in the transporter 3 may be controlled based on the determination result from the image inspector 4d to deliver the paper forming a flawed image to a catch tray different from an ordinary catch tray.

The controller 4 in the actual image inspection apparatus 1 is configured as a CPU (central processing unit), for example, and executes an installed program to perform the above-mentioned processes.

1-2. Configuration of the Image Forming Apparatus

The description below explains an overall configuration of the image forming apparatus containing the image inspection apparatus 1.

FIG. 2 illustrates an example configuration of the image forming apparatus 10 containing the image inspection apparatus 1.

The image forming apparatus 10 in FIG. 2 represents an electrophotographic image forming apparatus such as a copier. In particular, the example in FIG. 2 illustrates a so-called tandem type color image forming apparatus that vertically places a plurality of photoreceptors opposite a single intermediate transfer belt to form full-color images.

The image forming apparatus 10 includes an image generator 11, a paper transporter 20, a fuser 31, and a document reader 40.

The image generator 11 includes an image generator 11Y to generate images in yellow (Y), an image generator 11M to generate images in magenta (M), an image generator 11C to generate images in cyan (C), and an image generator 11BK to generate images in black (BK).

The image generator 11Y includes a photoreceptor drum Y, a charger 12Y placed nearby, an optical writer 13Y including a laser diode 130Y, a development apparatus 14Y, and a drum cleaner 15Y. Similarly, the image generators 11M, 11C, and 11BK include photoreceptor drums M, C, and BK, chargers 12M, 12C, and 12BK placed nearby, optical writers 13M, 13C, and 13BK including laser diodes 130M, 130C, and 130BK, development apparatuses 14M, 14C, and 14BK, and drum cleaners 15M, 15C, and 15BK, respectively.

The charger 12Y evenly charges the surface of the photoreceptor drum Y. The laser diode 130Y of the optical writer 13Y provides scanning exposure to form a latent image on the photoreceptor drum Y. The development apparatus 14Y uses a toner to develop and highlight the latent image on the photoreceptor drum Y. An image (toner image) in a specified color corresponding to yellow is thereby formed on the photoreceptor drum Y.

Similarly, the charger 12M evenly charges the surface of the photoreceptor drum M. The laser diode 130M of the optical writer 13M provides scanning exposure to form a latent image on the photoreceptor drum M. The development apparatus 14M uses a toner to develop and highlight the latent image on the photoreceptor drum M. A toner image in a specified color corresponding to magenta is thereby formed on the photoreceptor drum M.

The charger 12C evenly charges the surface of the photoreceptor drum C. The laser diode 130C of the optical writer 13C provides scanning exposure to form a latent image on the photoreceptor drum C. The development apparatus 14C uses a toner to develop and highlight the latent image on the photoreceptor drum C. A toner image in a specified color corresponding to cyan is thereby formed on the photoreceptor drum C.

The charger 12BK evenly charges the surface of the photoreceptor drum BK. The laser diode 130BK of the optical writer 13BK provides scanning exposure to form a latent image on the photoreceptor drum BK. The development apparatus 14BK uses a toner to develop and highlight the latent image on the photoreceptor drum BK. A toner image in a specified color corresponding to black is thereby formed on the photoreceptor drum BK.

The primary transfer rollers 17Y, 17M, 17C, and 17BK successively transfer toner images formed on the photoreceptor drums Y, M, C, and BK to predetermined positions on an intermediate transfer belt 16 as a belt-like intermediate transfer body. The secondary transferrer 18 transfers the respectively colored toner images transferred onto the intermediate transfer belt 16 to paper P transported by the paper transporter 20 at a predetermined timing.

The paper transporter 20 includes a plurality of paper feed trays 21 to contain paper P and a paper feeder 21a to feed paper P stored in the paper feed tray 21. The paper transporter 20 also includes a main transport path 23, a reverse transport path 24, and a catch tray 25. The main transport path 23 transports paper P fed from the paper feed tray 21. The reverse transport path 24 reverses two sides of paper P. Paper P is ejected to the catch tray 25.

Part of the paper transporter 20 functions as the transporter 3 (FIG. 1) of the image inspection apparatus 1. The detector 2 of the image inspection apparatus 1 is provided to a transport path (such as downstream of an exit roller 26) for the paper immediately before being transported to the catch tray 25. The detector 2 reads the paper transported to the catch tray 25. In FIG. 2, the detector 2 is configured to read one side (face) of paper P. However, the detector 2 is also placed at a position opposite the other side (reverse side) of paper P when reading images formed on both sides of paper P.

In the paper transporter 20, the reverse transport path 24 branches from the main transport path 23 downstream of the fuser 31. A switching gate 23a is provided at a branching position between the main transport path 23 and the reverse transport path 24. In the image forming apparatus 10, paper P is transported through the main transport path 23 and passes through the secondary transferrer 18 and the fuser 31. An image is formed on the upward surface of paper P. When images are formed on both sides of paper P, paper P formed of an image on the upward side is transported from the main transport path 23 to the reverse transport path 24 and then is transported from the reverse transport path 24 to the main transport path 23, flipping the image formation side downward. Both the sides of paper P are thereby reversed, making it possible to form an image on the other side faced upward.

The fuser 31 performs a fusing process to fuse an image on paper P where the image is transferred. The fuser 31 transports paper P and fuses the image on paper P by performing pressure fixing using a pair of fusing rollers 32 and 33 and performing heat fixing using a fusing heater 34.

The document reader 40 uses the optical system of a scanning exposure apparatus to apply scanning exposure to the image on a document and uses the line image sensor to read the reflected light and acquire image data. The image forming apparatus 10 can generate an image by using image data available from outside as well as acquiring image data read from the document reader 40. Any image data, if available, is converted into RIP data in a formation image processor (not shown) inside the image forming apparatus 10. The RIP data is used to form an image on paper P.

1-3. Image Inspection Process (During Proof Printing)

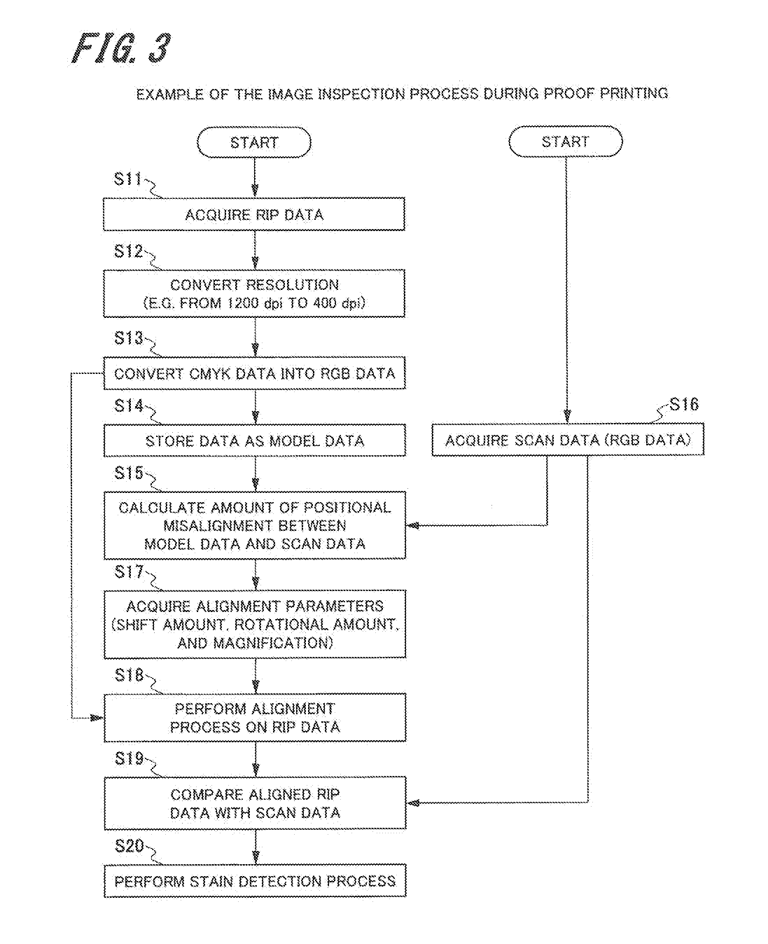

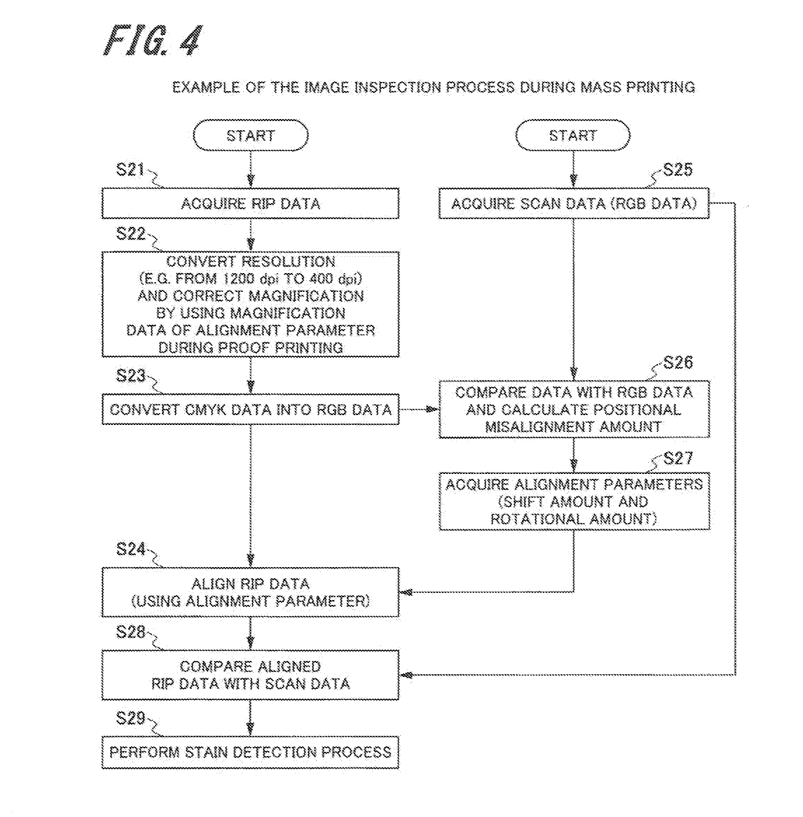

The description below explains a process to inspect images by using the image inspection apparatus 1 illustrated in FIG. 1. For example, the CPU configuring the controller 4 performs image inspection processes illustrated in flowcharts in FIGS. 3 and 4 below. The first embodiment performs different processes during proof printing for the first copy and during mass printing for the second and succeeding copies.

The description below first explains a flow of the image inspection process during proof printing with reference to the flowchart in FIG. 3.

First, the image inspection apparatus 1 acquires RIP data (targeted image data) from the image forming apparatus 10 via the acquirer 4a of the controller 4 (step S11). The alignment calculator 4b converts the resolution of the acquired RIP data (step S12). The resolution is converted in order to adjust the resolution of the RIP data to the resolution of read image data. For example, the alignment calculator 4b converts the resolution of the RIP data from 1200 dpi to 400 dpi.

The alignment calculator 4b converts the RIP data having the converted resolution from the data of C (cyan), M (magenta), Y (yellow), and K (black) color components as primary color components according to the subtractive color mixture for printing to data of R (red), G (green), and B (blue) color components as primary color components according to the additive color mixture (step S13). The converted RGB data is stored as model data in the storage 5 (step S14). The image data may include a variable region (where image contents differ on a copy-basis). In such a case, information in the variable region is eliminated from the model data. The variable region will be described later. The model data stored in the storage 5 is used for mass printing to be described later.

The detector 2 as an image reader acquires scan data as read image data (step S16). The scan data acquired by the detector 2 is equal to RGB data having a resolution of 400 dpi.

The alignment calculator 4b compares the model data stored at step S14 in the storage 5 with the scan data acquired at step S16 and calculates positional misalignment amounts for both the image data (step S15). The alignment calculator 4b calculates the positional misalignment amount at step S15 and thereby acquires a correction parameter for alignment (step S17). There are three correction parameters for the image shift, rotation, and magnification. During proof printing, the process to acquire the correction parameter at step S17 is performed on all pages. The storage 5 stores the magnification parameter for each page.

The alignment corrector 4c performs an alignment process on the RIP data by using the correction parameter acquired at step S17 (step S18). The RIP data used for the alignment is equal to the RGB data having a resolution of 400 dpi converted at step S13. The alignment process performed at step S18 allows the position of the RIP data to correspond to the position of the scan data.

The image inspector 4d performs an image inspection process by comparing the RIP data subject to the alignment process performed at step S18 with the scan data acquired from the detector 2 (step S19). The result of the comparison at step S19 may indicate a difference larger than or equal to a predetermined threshold value between the RIP data and the scan data acquired from the detector 2. The image inspector 4d then performs a stain detection process that assumes a stain in the image read by the detector 2 at the differing position (step S20).

The image inspection process during proof printing described so far requires a relatively large amount of arithmetic processing and is time-consuming while generating model data for alignment and calculating the positional misalignment amount for the model data and scanning. During proof printing, the image inspection process may not be performed in real time. Unprocessed scan data or RIP data needs to be temporarily saved in a high-capacity data storage (such as the storage 5 or an unshown hard disk) provided for the image inspection apparatus 1.

1-4. Image Inspection Process (During Mass Printing)

The description below first explains a flow of the image inspection process during mass printing (printing the second and succeeding copies) with reference to the flowchart in FIG. 4.

The image inspection apparatus 1 acquires RIP data (targeted image data) from the image forming apparatus 10 via the acquirer 4a of the controller 4 (step S21). The alignment calculator 4b converts the resolution of the acquired RIP data from 1200 dpi to 400 dpi (step S22). The alignment calculator 4b reads magnification data of the alignment parameter (correction parameter) used for the alignment during the proof printing from the storage 5 on a page basis and corrects the magnification of the RIP data by using the magnification data of the alignment parameter for each page.

The alignment calculator 4b converts the RIP data having the resolution converted and the magnification adjusted from CMYK data to RGB data (step S23).

The detector 2 as an image reader acquires scan data as read image data (step S25). The scan data acquired by the detector 2 is equal to RGB data having a resolution of 400 dpi.

The alignment calculator 4b compares the RIP data (RGB data) acquired at step S23 with the scan data acquired at step S25 and calculates the positional misalignment amount (step S26). The alignment calculator 4b acquires the alignment parameters (parameters for the shift amount and the rotational amount) from the result of calculating the positional misalignment amount at step S26 (step S27).

The alignment corrector 4c further performs the alignment process on the RIP data (RGB data) converted at step S23 by using the alignment parameters for the shift amount and the rotational amount acquired at step S27 (step S24).

The image inspector 4d performs the image inspection process by comparing the RIP data subject to the alignment process performed at step S24 with the scan data acquired from the detector 2 (step S28). The result of the comparison at step S28 may indicate a difference larger than or equal to a predetermined threshold value between the RIP data and the scan data acquired from the detector 2. The image inspector 4d then performs the stain detection process that assumes a stain in the image read by the detector 2 at the differing position (step S29).

1-5. Comparing Two Image Inspection Processes

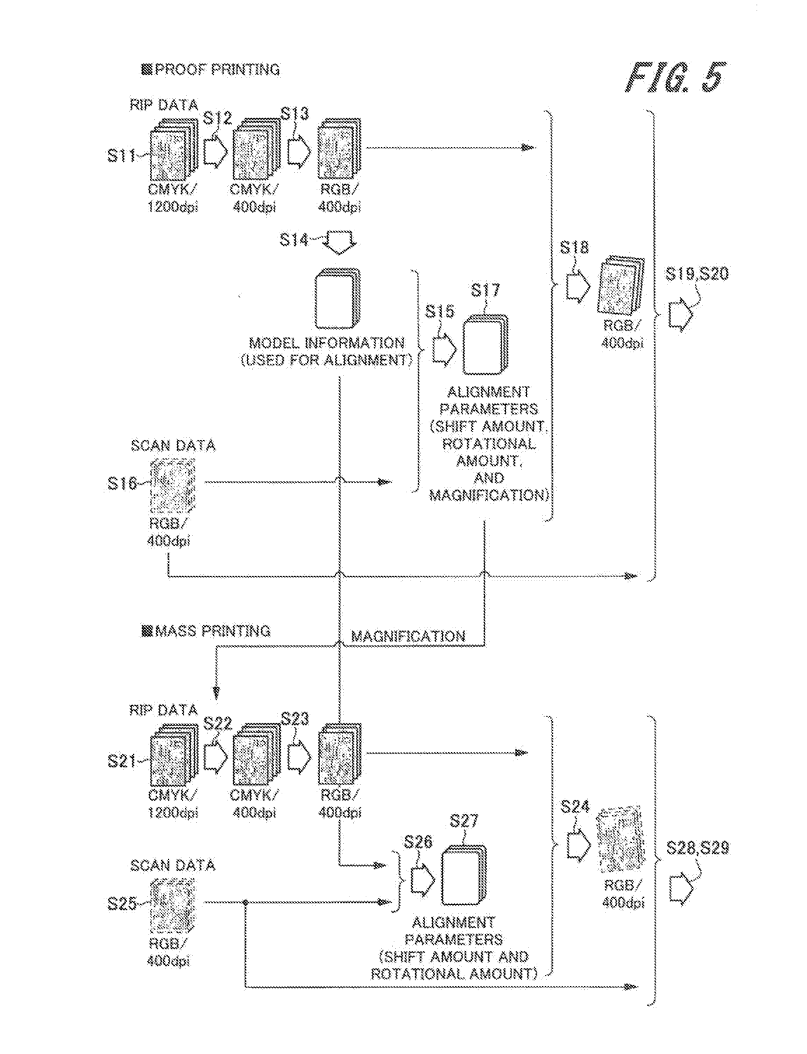

FIG. 5 illustrates an overview of the image inspection process during proof printing described with reference to the flowchart in FIG. 3 and the image inspection process during mass printing described with reference to the flowchart in FIG. 4. Step numbers such as S11 in FIG. 5 correspond to those in FIGS. 3 and 4.

As illustrated in the upper part of FIG. 5, the model data is generated at step S14 during proof printing. The model data and the scan data are used to acquire the alignment parameters (shift amount, rotational amount, and magnification) at step S17. The alignment parameters are used to perform the alignment correction on the RIP data at step S18. The comparison process to detect a stain is performed at step S19. The model data acquired at step S14 and the alignment parameter acquired at step S17 are comparable to data on a page basis.

As illustrated in the lower part of FIG. 5, the magnification of the RIP data is corrected on a page basis during mass printing by using the alignment parameter for magnification acquired at step S22 during proof printing. The RIP data having the corrected magnification is compared with the scan data at step S26. At step S27, the alignment parameters for the shift amount and the rotational amount (on a page basis) are acquired. At step S28, the alignment parameters for the shift amount and the rotational amount are used to correct the RIP data for each page and the comparison process for stain detection is performed.

As seen from the comparison between the proof printing in the upper part of FIG. 5 and the mass printing in the lower part thereof, the magnification correction is performed for each page at the beginning of the mass printing by using the alignment parameter during the proof printing. The mass printing therefore needs to acquire only the alignment parameters for the shift amount and the rotational amount at step S27.

Compared to the proof printing, the mass printing can greatly reduce the amount of arithmetic processing in the alignment parameter acquisition process and the subsequent alignment process. The real-time image inspection process is available during the mass printing.

Each parameter is acquired on a page basis and the acquired page based data is applied to data for the corresponding page during mass printing. The alignment correction can be performed appropriately even when a condition such as the paper type differs from page to page.

The real-time image inspection process is available. The image inspection apparatus can therefore transport flawed pages and unflawed pages separately to different catch trays in real time.

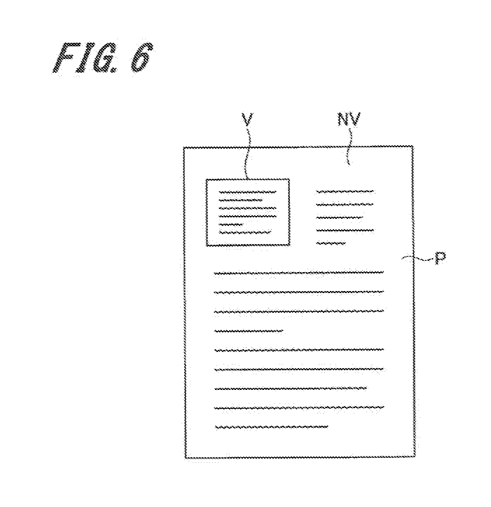

FIG. 6 illustrates the variable region used when the model data is generated at step S14 of the flowchart in FIG. 3.

When forming an image on paper P, the image forming apparatus 10 may require variable region V to print contents such as names and addresses differing from copy to copy. The same image is printed on all copies in non-variable region NV other than variable region V.

Information about variable region V needs to be removed from the model data when variable region V is provided. Removing variable region V from the model data enables an appropriate process using the model data during mass printing.

As above, the present embodiment can reduce the amount of arithmetic processing for the alignment, shorten the time for the alignment process, and enable the real-time inspection even when a condition such as the paper type differs from page to page. The real-time inspection enables a process that delivers flawed pages and unflawed pages to different catch trays in real time.

### 2. Second Embodiment

The second embodiment of the present invention will be described.

The second embodiment also applies the same configurations illustrated in FIGS. 1 and 2 described in the first embodiment to the image inspection apparatus 1 or the image forming apparatus 10.

As will be described later, the second embodiment differs from the first embodiment in process flows during proof printing and mass printing. The second embodiment performs different stain detection processes on variable region V and non-variable region NV illustrated in FIG. 6 during mass printing.

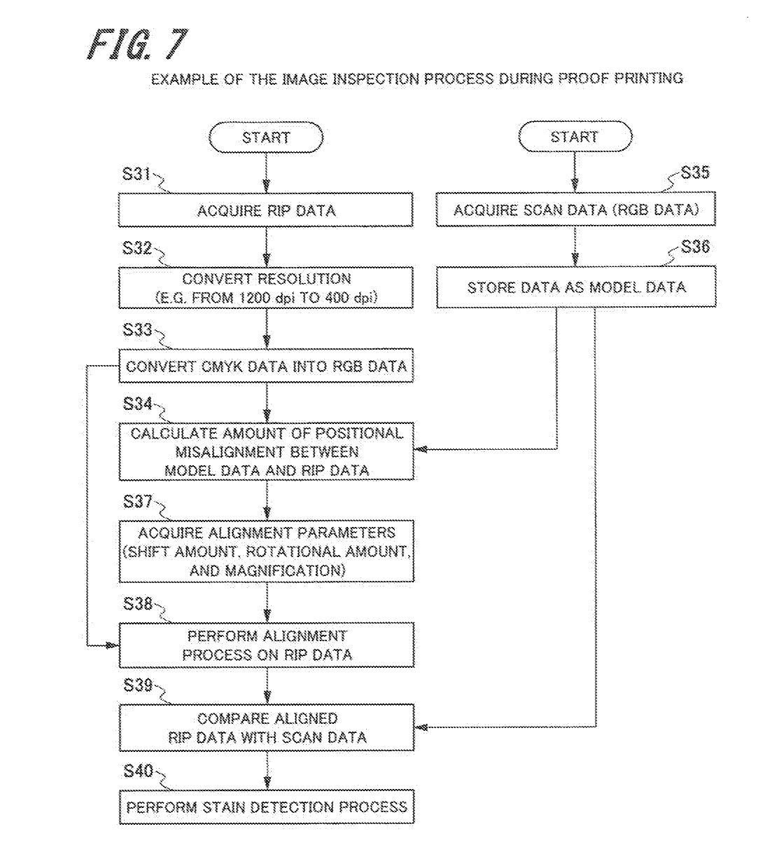

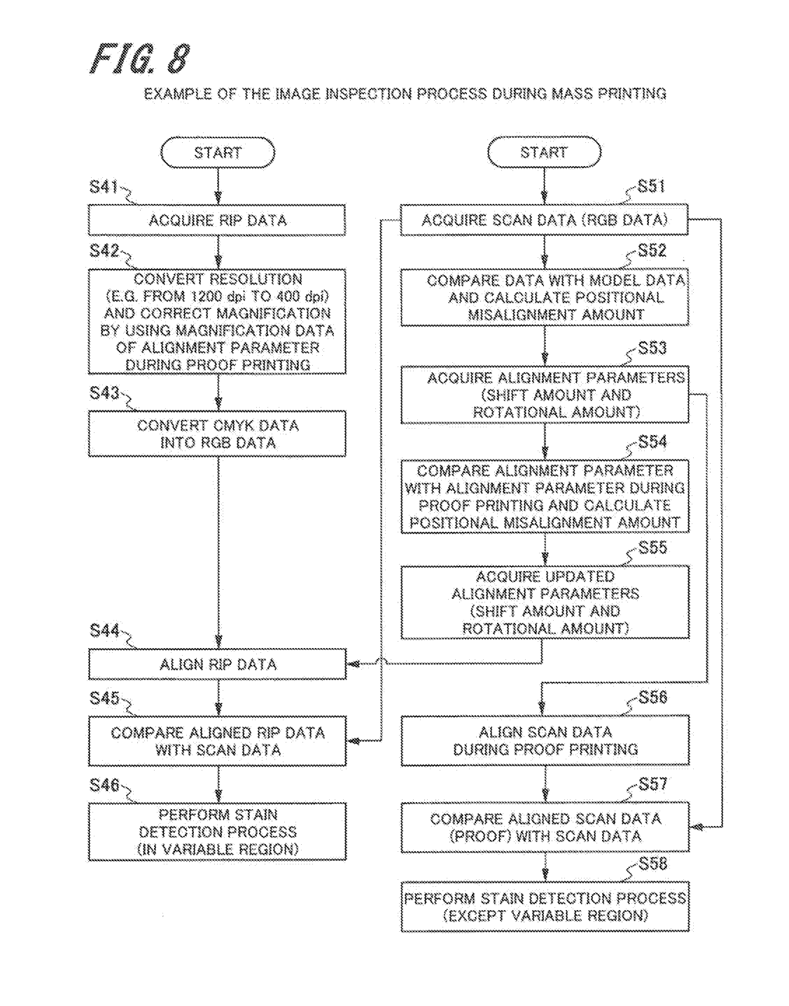

For example, the CPU configuring the controller 4 performs image inspection processes illustrated in flowcharts in FIGS. 7 and 8 below.

2-1. Image Inspection Process (During Proof Printing)

FIG. 7 is a flowchart illustrating a flow of the image inspection process during proof printing.

With reference to FIG. 7, the image inspection apparatus 1 first acquires RIP data (targeted image data) from the image forming apparatus 10 via the acquirer 4a of the controller 4 (step S31). The alignment calculator 4b converts the resolution of the acquired RIP data (step S32). The resolution is converted in order to adjust the resolution (1200 dpi) of the RIP data to the resolution (400 dpi) of read image data. The alignment calculator 4b further converts the RIP data having the converted resolution from CMYK data to RGB data (step S33).

The detector 2 as an image reader acquires scan data as read image data (step S35). The scan data acquired by the detector 2 is equal to RGB data having a resolution of 400 dpi. The alignment calculator 4b acquires the scan data and stores it as model data in the storage 5 (step S36).

The alignment calculator 4b compares the RIP data converted at step S33 with the model data acquired at step S36 and calculates a positional misalignment amount (step S34). The alignment calculator 4b acquires the alignment parameters (shift amount, rotational amount, and magnification) from the positional misalignment amount calculated by this comparison (step S37). During proof printing, the process at step S37 to acquire the alignment parameters is performed on all pages. The magnification parameter for each page is stored in the storage 5.

The alignment corrector 4c performs the alignment process on the RIP data by using the alignment parameters acquired at step S37 (step S38). This alignment process allows the RIP data to be aligned with the scan data.

The image inspector 4d performs the image inspection process by comparing the RIP data subject to the alignment process performed at step S38 with the model data (scan data) acquired at step S36 (step S39). The result of the comparison at step S39 may indicate a difference larger than or equal to a predetermined threshold value between the RIP data and the scan data. The image inspector 4d then performs the stain detection process that assumes a stain in the image read by the detector 2 at the differing position (step S40).

Similarly to the example in FIG. 3 (first embodiment), the image inspection process during proof printing as illustrated by the flowchart in FIG. 7 also requires a relatively large amount of arithmetic processing and is time-consuming while generating model data for alignment and calculating the positional misalignment amount for the model data and scanning. During proof printing, the image inspection process may not be performed in real time. Unprocessed scan data or RIP data needs to be temporarily saved in a high-capacity data storage provided for the image inspection apparatus 1.

2-2. Image Inspection Process (During Mass Printing)

With reference to the flowchart in FIG. 8, the description below explains a flow of the image inspection process during mass printing (the second and succeeding copies).

The image inspection apparatus 1 first acquires RIP data (targeted image data) from the image forming apparatus 10 via the acquirer 4a of the controller 4 (step S41). The alignment calculator 4b converts the resolution of the acquired RIP data from 1200 dpi to 400 dpi (step S42). The alignment calculator 4b reads magnification data of the alignment parameter used for the alignment during the proof printing from the storage 5 on a page basis and corrects the magnification of the RIP data by using the magnification data of the alignment parameter for each page.

The alignment calculator 4b converts the RIP data having the resolution converted and the magnification adjusted from CMYK data to RGB data (step S43).

The detector 2 as an image reader acquires scan data as read image data (step S51). The scan data acquired by the detector 2 is equal to RGB data having a resolution of 400 dpi.

The alignment calculator 4b compares the scan data acquired at step S51 with the model data stored in the storage 5 and calculates the positional misalignment amount (step S52). The alignment calculator 4b acquires the alignment parameters (parameters for the shift amount and the rotational amount) from the result of calculating the positional misalignment amount at step S52 (step S53).

The alignment calculator 4b compares the alignment parameter during proof printing with the alignment parameter acquired at step S53 and calculates the positional misalignment amount based on a difference between both (step S54). The positional misalignment amount calculated at step S54 is used to update the alignment parameter during the proof printing. The alignment calculator 4b acquires the updated alignment parameters (parameters for the shift amount and the rotational amount) (step S55).

The alignment corrector 4c performs the alignment process on the RIP data (RGB data) acquired at step S43 by using the alignment parameters updated at step S55 (step S44). The image inspector 4d performs the image inspection process by comparing the RIP data subject to the alignment process performed at step S44 with the scan data acquired from the detector 2 (step S45). The image inspection process at step S45 is performed on an image in variable region V. The result of the comparison at step S45 may indicate a position corresponding to a difference larger than or equal to a predetermined threshold value. The image inspector 4d then performs the stain detection process that assumes a stain in variable region V corresponding to the image read by the detector 2 (step S46).

The alignment corrector 4c aligns scan data (model data) during the proof printing by using the alignment parameters acquired at step S53 (step S56). The image inspector 4d performs the image inspection process by comparing the scan data (model data) aligned at step S56 with the scan data acquired at step S51 (step S57). The image inspection process at step S57 is performed on an image in non-variable region NV. The result of the comparison at step S57 may indicate a difference larger than or equal to a predetermined threshold value between the scan data (model data) aligned at step S56 and the scan data acquired at step S51. The image inspector 4d then performs the stain detection process that assumes a stain in non-variable region NV corresponding to the image read by the detector 2 (step S58).

2-3. Comparing Two Image Inspection Processes

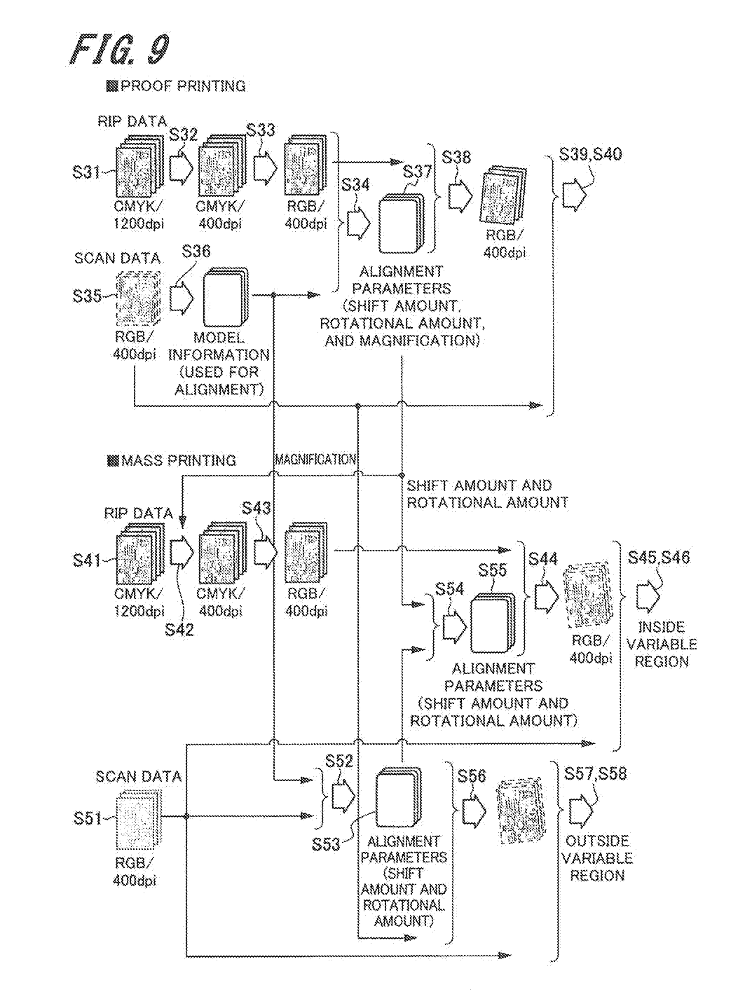

FIG. 9 illustrates an overview of the image inspection process during proof printing described with reference to the flowchart in FIG. 7 and the image inspection process during mass printing described with reference to the flowchart in FIG. 8. Step numbers such as S31 in FIG. 9 correspond to those in FIGS. 7 and 8.

As illustrated in the upper part of FIG. 9, the model data is generated from the scan data at step S36 during proof printing. The model data and the RIP data are used to acquire the alignment parameters (shift amount, rotational amount, and magnification) at step S38. The alignment parameters are used to perform the alignment correction on the RIP data at step S38. The comparison process to detect a stain is performed at step S39. The model data acquired at step S36 and the alignment parameters acquired at step S37 are comparable to data on a page basis.

As illustrated in the lower part of FIG. 9, the magnification of the RIP data is corrected on a page basis during mass printing by using the alignment parameter for magnification acquired at step S42 during proof printing. The comparison between the scan data and the model data (page-based) at step S52 acquires the alignment parameters (shift amount and rotational amount) at step S53. At step S57, the model data corrected by using the alignment parameters acquired at step S53 is compared with the scan data acquired at step S51. A stain is detected in non-variable region NV at step S58.

At step S55, the alignment parameters acquired at step S53 are used to update the alignment parameters during proof printing. At step S44, the updated alignment parameters are used to align the RIP data whose magnification is corrected. At step S45, the RIP data aligned at step S44 is compared with the scan data acquired at step S51. At step S46, a stain in variable region V is detected.

As seen from the comparison between the proof printing in the upper part of FIG. 9 and the mass printing in the lower part thereof, the mass printing uses the model data and the alignment parameters during the proof printing and can therefore greatly reduce the amount of arithmetic processing in the alignment process when compared to the proof printing. The real-time image inspection process is available during the mass printing.

The processing conditions are changed depending on variable region V and non-variable region NV, making it possible to appropriately detect a stain in regions V and NV.

### 3. Modifications

The above-mentioned embodiments configure the image inspection apparatus 1 as being contained in the image forming apparatus 10. However, the image inspection apparatus 1 may be configured separately from the image forming apparatus. FIG. 2 provides one example of the configuration of the image forming apparatus used in combination with the image inspection apparatus 1. The configuration is applicable to image forming apparatuses according to the other various systems.

As illustrated at step S18 in FIG. 3, the alignment process according to the above-mentioned embodiments corrects the position of the RIP data based on the parameters so as to be adjusted to the scan data. However, positions of the scan data may be corrected based on the parameters. Alternatively, the position correction of the RIP data may be combined with that of the scan data.

Although embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

1 . . . image inspection apparatus, 2 . . . detector, 3 . . . transporter, 4 . . . controller, 4a . . . acquirer, 4b . . . alignment calculator, 4c . . . alignment corrector, 4d . . . image inspector, 5 . . . storage, 10 . . . image forming apparatus, P . . . paper, V . . . variable region, NV . . . non-variable region

What is claimed is:

1. An image inspection apparatus that reads an image formed on paper by an image forming apparatus, acquires a read image, and inspects the read image, the image inspection apparatus comprising:
an acquirer that acquires a targeted image for the image forming apparatus to form an image;
an alignment calculator that calculates a correction parameter to align the targeted image with the read image;
an alignment corrector that corrects at least one of the targeted image and the read image by using the correction parameter; and
an image inspector that determines a flaw in the read image based on a difference between the targeted image and the read image corrected by the alignment corrector,
wherein the alignment corrector saves the correction parameter on a page basis and uses the correction parameter corresponding to a page including an image when aligned.

2. The image inspection apparatus according to claim 1,
wherein the alignment corrector performs:
a variable magnification process that variably magnifies at least one of the targeted image and the read image in order to correct a size error between the targeted image and the read image;
a shift process that shifts at least one of the targeted image and the read image; and
a rotation process that rotates at least one of the targeted image and the read image.

3. The image inspection apparatus according to claim 2,
wherein the correction parameter conforms to a magnification and the variable magnification process varies a magnification by using a magnification corresponding to a page.

4. The image inspection apparatus according to claim 1,
wherein the correction parameter is acquired during proof printing.

5. The image inspection apparatus according to claim 1,
wherein, when determining a flaw in the read image, the image inspector selectively uses an image to be compared depending on whether a variable region is targeted for comparison, and selectively uses the saved correction parameter.

6. A computer-readable recording medium storing a program that reads an image formed on paper by an image forming apparatus, acquires a read image, and inspects the read image, the computer-readable recording medium causing a computer to perform:
an acquisition process that acquires targeted image to form an image;
an alignment calculation process that calculates a correction parameter to align the targeted image with the read image;
an alignment correction process that corrects at least one of the targeted image and the read image by using the correction parameter; and
an image inspection process that determines a flaw in the read image based on a difference between the targeted image and the read image corrected by the alignment correction process,
wherein the alignment correction process saves the correction parameter on a page basis and uses the correction parameter corresponding to a page including an image when aligned.

7. The computer-readable recording medium storing a program according to claim 6,
wherein the alignment correction process performs:
a variable magnification process that variably magnifies at least one of the targeted image and the read image in order to correct a size error between the targeted image and the read image;
a shift process that shifts at least one of the targeted image and the read image; and
a rotation process that rotates at least one of the targeted image and the read image.

8. The computer-readable recording medium storing a program according to claim 7,
wherein the correction parameter conforms to a magnification and the variable magnification process varies a magnification by using a magnification corresponding to a page.

9. The computer-readable recording medium storing a program according to claim 6,
wherein the correction parameter is acquired during proof printing.

10. The computer-readable recording medium storing a program according to claim 6,
wherein, when determining a flaw in the read image, the image inspection process selectively uses an image to be compared depending on whether a variable region is targeted for comparison, and selectively uses the saved correction parameter.
